(19) United States
(12) Patent Application Publication
(10) Pub. No.: US 2007/0000740 A1
(43) Pub. Date: Jan. 4, 2007

(54) Brake pad dust collector or diverter

(76) Inventor: Simon Raab, Santa Barbara, CA (US)

Correspondence Address: CANTOR COLBURN, LLP, 55 GRIFFIN ROAD SOUTH, BLOOMFIELD, CT, 06002, US

(21) Appl. No.: 11/401,988

(22) Filed: Apr. 11, 2006

Related U.S. Application Data
(60) Provisional application No. 60/670,220, filed on Apr. 11, 2005.

(51) Int. Cl. F16D 65/00

(52) U.S. Cl. 188/218 A

(57) ABSTRACT

A brake pad dust collector or diverter is described, which includes a brake caliper extension operatively associated with the brake pad, the extension shaped or configured so as to divert and/or collect brake dust.

### CROSS REFERENCE TO RELATED APPLICATIONS

The present application claims priority to co-pending U.S. Provisional Patent Application Ser. No. 60/670,220, filed Apr. 11, 2005, the entire contents of which are specifically incorporated herein by reference.

### BACKGROUND

Brake pads are made of a compressed combination of metal, plastic asbestos and other compounds designed to be effective at elevated operating temperatures, while also resisting excessive wear. While such technology is effective for braking and provides a more easily serviceable brake configuration, the advent of the disc brake has culminated in an ongoing aesthetic problem.

The problem is most visible with regard to inclusion of disc brakes and alloy wheels in the same design. The aesthetic problem occurs as the dust from the brake pads deposits on the alloy wheels. The dust is a combination of carbon fibers, metal filings and polymer adhesives. Because the dust contains adhesive residue, the dust leaves a fine gray, brown and black film on the surface of the alloy wheels. In a matter of days, the film degrades the appearance of the alloy wheels. Further, the film is often not easily removed, resulting in headache for the vehicle owner.

Where the film is not periodically removed, the acidic content in the film also can etch into the finish of alloy wheels. Thus, the problem presented by brake dust goes further than mere aesthetics.

Significant efforts have been underway to solve this problem. Primarily, the industry has produced brake pads or disc brake materials formulated to reduce the amount of dust produced. Automobile owners often switch to Kevlar or carbon Kevlar pads, which produce somewhat less dust. While producing less dust, these pads are typically somewhat harder on the rotor.

The only other option has heretofore been installing a disc of metal or plastic against the inside surface of the wheel. The disc seals the brake area from the wheel and stops the brake dust from depositing on the wheel.

However, the aesthetics of this design are generally not acceptable, since the disc is visible through the wheel and since the brake calipers and rotors are obstructed from view. Car owners prefer the look of the brake calipers and rotors behind the alloy wheel. Further, the disc hinders airflow through the alloy wheel spokes and may result in deficient brake cooling resulting in fade and rotor warping.

What is needed in the art is an alternate, aesthetically pleasing mechanism for managing the problem presented by brake dust deposited on wheel surfaces.

### SUMMARY

The above discussed and other problems and deficiencies of the prior art are overcome and alleviated by the presently described brake pad dust collector or diverter, which includes a brake caliper extension operatively associated with the brake pad, the extension shaped and configured so as to divert and/or collect brake dust.

In one embodiment, the extension is shaped or configured to provide at least one airflow path, such airflow generated by the rotation of a wheel and rotor and directed by said extension of said caliper, the airflow path directed over an edge of the rotor and away from the wheel surfaces.

In another embodiment, the extension is configured with a cavity having a construction effective to trap brake dust. Such cavity may have a high surface area, e.g., created by a convoluted surface. The surfaces of the extension may also be prepared to adhere dust, e.g., as by including one or more replaceable filters.

The above-discussed and other features and advantages of the presently described brake pad dust diverter or collector will be appreciated and understood by those skilled in the art from the following detailed description and drawings.

### BRIEF DESCRIPTION OF THE DRAWINGS

Referring now to the drawings, wherein like elements are numbered alike in the several FIGURES:

FIG. 1 is a side view of an exemplary brake pad dust diverter or collector; and

FIG. 2 is a front view of an exemplary brake pad dust diverter or collector.

### DETAILED DESCRIPTION OF EXEMPLARY EMBODIMENTS

Reference will now be made in detail to exemplary embodiments, examples of which are illustrated in the accompanying drawings.

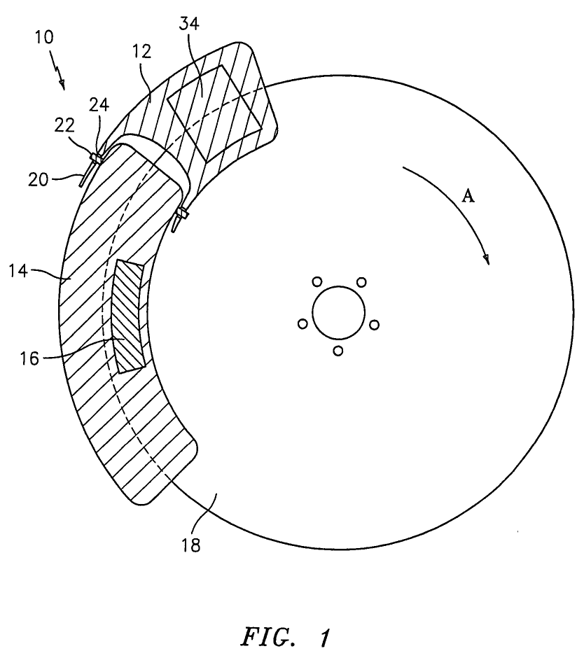

With reference to FIG. 1, the presently described brake pad dust diverter or collector, illustrated generally at 10, comprises at least one caliper extension 12 operatively associated with caliper portion 14, which holds a brake pad 16 against a rotor 18. For purposes of illustration and discussion, extension 12 is illustrated in a “forward” position, that is, forward along a first rotational direction A relative to brake pad 16 (which rotation effects forward movement of the automobile). It should be noted that an extension may, in any instance, be positioned in a “rearward” position in addition to, or in lieu of the “forward” position.

While the extension 12 may be bolted on, snapped on, adhered on (e.g., as with a high temperature adhesive tape) or the equivalent, the illustrated exemplary embodiment of FIG. 1 shows a snap on configuration, wherein the material of the extension 12 may deflect sufficiently such that an arm 20 thereof slides over a pin 22 on the caliper, which engages a hole 24 in the arm 20. It should also be noted that while extension 12 is illustrated as a removable piece relative to the caliper, extension 12 may also be a non-removable piece or contiguous portion of the caliper.

Referring still to FIG. 1, as illustrated in the exemplary embodiment, the extension 12 may extend at least partially beyond the circumference of the rotor 18. An interior surface of the extension (not shown) may be angled or otherwise oriented to facilitate directing of airflow caused by rotation of the wheel and rotor (relative to the largely stationary caliper and extension).

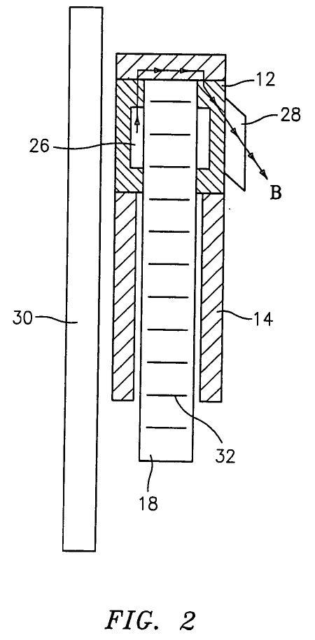

Additionally, with reference to FIG. 2, at least one interior airflow channel 26 or port 28 may be provided to direct airflow along a path (e.g., along airflow path B) or away from the wheel surfaces 30. The rotor 18 may also be vented (see vents 32) or otherwise apertured or contoured adjacent such extension to further facilitate airflow.

While an airflow path may be created by virtue of the orientation and/or the configuration of the extension 12, the extension may also incorporate a dust collection mechanism, such as a filter, a pad, a convoluted surface or cavity, or the like. Additionally, the surface of the extension could be prepared to adhere brake dust. Reference is made to FIG. 1, which illustrates exemplary positioning of a filter or pad 34.

The materials of the extension may be any convenient material, including but not limited to a fiber filled high temperature plastic, a metal, or any other durable material. Where a filter or pad is included, such may be removable (e.g., a removable filter cartridge) for replacement or cleaning.

Additionally, where the extension 12 is not integral with or permanently adhered to the caliper, the extension 12 may be attached in such a way so as to permit relatively facile removal and cleaning.

It will be apparent to those skilled in the art that, while exemplary embodiments have been shown and described, various modifications and variations can be made to the embodiments disclosed herein without departing from the spirit or scope of the invention. Accordingly, it is to be understood that the various embodiments have been described by way of illustration and not limitation.

What is claimed is:

1. An automobile brake pad dust diverter, comprising:
a caliper extension operatively associated with a brake caliper, the caliper extension positioned to direct airflow generated by a rotating wheel or a rotating rotor across an area adjacent the rotor and away from a wheel surface.

2. The automobile brake pad dust diverter in accordance with claim 1, wherein said extension is positioned to direct airflow across a circumference of said rotor and away from said wheel surface.

3. The automobile brake pad dust diverter in accordance with claim 1, wherein said extension is angled relative to a plane parallel with a face of said rotor.

4. The automobile brake pad dust diverter in accordance with claim 1, wherein said extension includes at least one internal channel directing airflow across or around a surface of said rotor.

5. The automobile brake pad dust diverter in accordance with claim 4, wherein said internal channel interacts with apertures in said rotor to generate airflow across or around a surface of said rotor.

6. The automobile brake pad dust diverter in accordance with claim 1, wherein said extension is removably attached to said caliper.

7. The automobile brake pad dust diverter in accordance with claim 6, wherein said extension is attached by means of a deformable arm having an aperture or a pin interacting with an aperture or a pin of said caliper.

8. The automobile brake pad dust diverter in accordance with claim 6, wherein said extension is attached by means of an adhesive or tape, a clam shell over the top of said caliper, a spring clip, or a set screw.

9. The automobile brake pad dust diverter in accordance with claim 1, wherein said extension includes at least one airflow exit port directed away from said wheel surface.

10. The automobile brake pad dust diverter in accordance with claim 1, wherein said extension includes a brake dust collector component.

11. The automobile brake pad dust diverter in accordance with claim 10, wherein such brake dust collector component comprises a filter, a convoluted surface of said extension or other cavity, or a pad.

12. The automobile brake pad dust diverter in accordance with claim 11, wherein said brake dust collector component is removable or replaceable.

13. An automobile brake pad dust collector, comprising:
a caliper extension operatively associated with a brake caliper, the caliper extension positioned to collect brake dust generated by a brake pad held by said brake caliper.

14. The automobile brake pad dust diverter in accordance with claim 13, wherein such brake dust collector component comprises a filter, a convoluted surface of said extension or other cavity, or a pad.

15. The automobile brake pad dust diverter in accordance with claim 13, wherein said brake dust collector component is removable or replaceable.
